(19) United States
(12) Patent Application Publication
(10) Pub. No.: US 2014/0032172 A1
(43) Pub. Date: Jan. 30, 2014

(54) SYSTEMS AND METHODS FOR HEALTH ASSESSMENT OF A HUMAN-MACHINE INTERFACE (HMI) DEVICE

(71) Applicants: Kevin Thomas McCarthy, Troy, NY (US); Raghavendra Prasad Rachepalli, Hyderabad (IN); Goutam Banerjee, Hyderabad (IN); Ayush Srivastava, Hyderabad (IN)

(72) Inventors: Kevin Thomas McCarthy, Troy, NY (US); Raghavendra Prasad Rachepalli, Hyderabad (IN); Goutam Banerjee, Hyderabad (IN); Ayush Srivastava, Hyderabad (IN)

(73) Assignee: GENERAL ELECTRIC COMPANY, Schenectady, NY (US)

(21) Appl. No.: 13/557,148

(22) Filed: Jul. 24, 2012

(51) Int. Cl. G06F 15/00

(52) U.S. Cl. 702/183

(57) ABSTRACT

A system includes a human machine interface (HMI) health advisor system including a health advisor suite having a processor. The processor of the health advisor suite is configured to receive operational data regarding a HMI device, wherein the operational data includes configuration data, log data, or a combination thereof. The processor is also configured to apply a plurality of rules to the operational data to proactively determine a HMI issue. The processor is also configured to identify a solution to the HMI issue from a plurality of known solutions to HMI issues. The processor is further configured to generate a configuration report for the HMI device based on the configuration data and to generate a health assessment report for the HMI device. Additionally, the health assessment report comprises the HMI issue and the solution to the HMI issue.

### BACKGROUND OF THE INVENTION

The subject matter disclosed herein relates to the reliability of industrial control systems, and more specifically, to the reliability of human machine interface (HMI) devices in industrial control systems.

Industrial control systems generally include a variety of components and subsystems participating to control a process. For example, an industrial controller of an industrial control system may include one or more processors, I/O subsystems, memory, and the like. Additionally, the industrial controller may be operatively coupled to a variety of other devices and/or systems to, for example, control an industrial process. As such, industrial control systems may be complex, including numerous interrelated components and subsystems. Accordingly, recognizing or predicting a reliability of industrial control system operations may be difficult and time-consuming

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In an embodiment, a system includes a human machine interface (HMI) health advisor system including a health advisor suite having a processor. The processor of the health advisor suite is configured to receive operational data regarding a HMI device, wherein the operational data includes configuration data, log data, or a combination thereof. The processor is also configured to apply a plurality of rules to the operational data to proactively determine a HMI issue. The processor is also configured to identify a solution to the HMI issue from a plurality of known solutions to HMI issues. The processor is further configured to generate a configuration report for the HMI device based on the configuration data and to generate a health assessment report for the HMI device. Additionally, the health assessment report comprises the HMI issue and the solution to the HMI issue.

In another embodiment, a method includes receiving, via a processor of an electronic device, configuration data, log data, or both, from a human machine interface (HMI) device. The method also includes applying, via the processor, a plurality of rules to the configuration data, the log data, or both, to predict one or more potential future maintenance issues for the HMI device. The method also includes determining, via the processor, one or more corresponding solutions from a plurality of known solutions for the one or more potential future maintenance issues for the HMI device. The method further includes reporting a health assessment of the HMI device, wherein the health assessment comprises the one or more potential future maintenance issues for the HMI device and the one or more corresponding solutions.

In a third embodiment, a non-transitory, computer-readable medium includes instructions executable by a processor of an electronic device. The instructions include instructions to receive a command to proceed with a health assessment of a human machine interface (HMI) device. The instructions include instructions to receive operational data regarding a human machine interface (HMI) device. The instructions include instructions to receive a plurality of rules from a health advisor database. The instructions include instructions to apply the plurality of rules to the operational data to predict a future problem relating to the HMI device. The instructions also include instructions to receive a plurality of known solutions from a knowledge base based, at least in part, on the future problem relating to the HMI device. The instructions also include instructions to provide a health assessment report, wherein the health assessment report comprises the future problem of the HMI device and one or more of the plurality of known solutions.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an schematic diagram of an embodiment of a health advisor communicatively coupled to a human machine interface (HMI) of an industrial control system;

FIG. 2 is a schematic diagram illustrating various components of the industrial control system and the associated health advisor system; and

FIG. 3 is a hybrid flow diagram illustrating the flow of information as the health advisor assesses the health of the HMI of the industrial control system.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As mentioned, an industrial control system may control of operations for an industrial process and associated machinery, such as a gas turbine system, a steam turbine system, a hydroturbine system, a wind turbine system, a gasifier, a gas treatment system (e.g, acid gas removal system), a heat recovery steam generator (HRSG), a power generation system, a chemical production system, a water processing system, or any combination thereof Such industrial control systems may be implemented as a combination of hardware and software components suitable for receiving inputs (e.g., process inputs), processing the inputs, and deriving certain control actions useful in controlling a machinery or process (e.g., a power generation process). One component of the industrial control system is a human machine interface (HMI). Generally speaking, the HMI may allow an operator to visualize and adjust the parameters and conditions of the controlled process.

Like other components of the industrial control system, over time the HMI may gradually experience a loss of reliability, for example, as the hardware and/or software of the HMI (e.g., operating system, security patches, applications, etc.) becomes dated and/or obsolete. This loss of reliability may be evidenced by an increase in unexpected maintenance events for the HMI. While corrective maintenance (CM) techniques may be useful in repairing and/or updating the HMI after unexpected maintenance events have occurred, such techniques do not preemptively prevent or block the HMI from entering a non-functional state. Further, when the HMI is non-functional due to an unexpected maintenance event, the operator may lose the status of equipment and parameters in the industrial control system. Furthermore, the operator may not be able to use the HMI to visualize and/or adjust the parameters and conditions of the controlled process until the HMI system is brought back to a desired operating condition, which may be problematic for the industrial control system.

With the foregoing in mind, described herein are proactive health assessment techniques that may preemptively identify potential HMI issues (e.g., conflicts, failures, software bugs, security vulnerabilities, and the like) and enable proactive HMI maintenance to preventatively address these potential issues, improving the operability and the up-time of the HMI and the industrial control system. Accordingly, the presently disclosed techniques may obviate some or all of the down-time associated with other maintenance techniques (e.g., CM) by predicting potential failure events such that they may be addressed before they occur. Accordingly, HMI maintenance actions, such as applying operating system patches, software upgrades, configuration adjustments, security enhancements, hardware replacement, hardware upgrades, and the like, may be performed in advance of HMI failure based on the recommendations of the disclosed HMI health advisor system. Furthermore, in certain embodiments, the presently disclosed HMI health advisor system may be part of a larger health advisor system or application, which may include components configured to assess the health of other components of the industrial control system, in addition to the HMI device. Accordingly, the presently disclosed techniques generally enable the HMI, as well as the industrial control system, to maintain an operational status for longer durations.

Furthermore, as set forth below, the presently disclosed HMI health advisor system generally utilizes a rule-based system to analyze and derive the health assessment for the HMI from the operational data of the HMI. As a result, the HMI health advisor system may output one or more reports regarding the health of the HMI. The reports may include configuration information; hardware installation, removal, and/or replacement recommendations; software installation, removal, and/or replacement recommendations; security recommendations, and the like for the HMI device. Additionally, in certain embodiments, the HMI health assessment may be provided in real-time or near real-time or on a periodic basis. For example, in certain embodiments, the HMI health assessment may be derived continuously and used to update or improve the HMI, thus providing for an up-to-date prognosis of the health of the HMI.

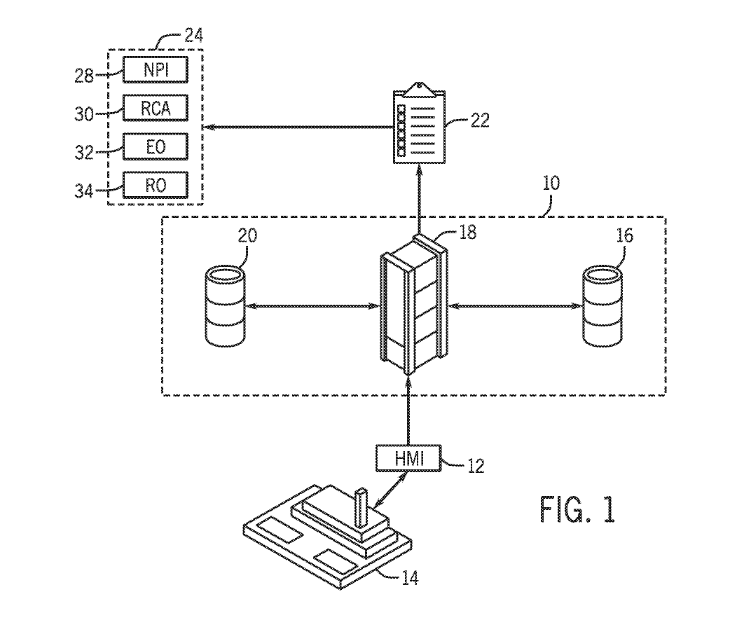

With the foregoing in mind and turning now to FIG. 1, a diagram illustrates an embodiment of a HMI health advisor system 10 communicatively coupled to an HMI device 12. The HMI health advisor system 10 may include non-transitory code or instructions stored in a machine-readable medium and used by a computing device (e.g., computer, tablet, laptop, notebook, cell phone, personal digital assistant) to implement the techniques disclosed herein. The HMI 12 may be used, for example, to provide an operator with an interface for visualizing and controlling the various parameters of the industrial control system 14. In FIG. 1, the illustrated industrial control system is a power plant 14. The illustrated power plant 14 may be any type of power producing plant 14, and may include turbomachinery, such as a gas turbine, a steam turbine, a wind turbine, a hydroturbine, a pump, a compressor, or other suitable components. The turbines may also be coupled to electrical generators to produce power. The plant 14 may also, for example, include a gasification system (e.g., one or more gasifiers) configured to gasify a carbonaceous feedstock to produce a syngas, which may be processed by a gas treatment system before use by a gas turbine driven generator. It should be noted that, in certain embodiments, the HMI 12 may be used by an operator to visualize and/or control a number of different industrial control systems 14 (e.g., manufacturing plants, chemical plants, oil refining plants, or other suitable industrial control system) including a variety of suitable equipment (e.g., gasification systems, turbine systems, gas treatment systems, power generation systems, air separation unit, heat recovery steam generators (HRSGs), automated assembly lines, or other suitable industrial equipment).

The embodiment of the HMI health advisor system 10 illustrated in FIG. 1 includes a health advisor database 16, a health advisor suite (e.g., suite of software and/or hardware tools) 18, and a knowledge base 20. In certain embodiments, the health advisor suite 18, the health advisor database 16, and/or the knowledge base 20 may include instructions executed by the same processor (e.g., hosted by a common machine, computer, or server). In other embodiments, each of the health advisor database 16, health advisor suite 18, and the knowledge base 20 may be separately executed by different processors (e.g., hosted by different machines, computers, or servers).

In general, the health advisor suite 18 may control the operation of the health advisor system 10. That is, as set forth below, the health advisor suite 18 may receive information (e.g., configuration information and log data) associated with the HMI 12 and, subsequently, utilize rules stored in the health advisor database 16 to analyze the received HMI information. The health advisor suite 18 may then utilize information stored in the knowledge base 20 to determine recommendations for the HMI 12, based on the analyzed HMI information. Subsequently, the HMI health advisor suite 18 may output one or more reports 22, the contents of which may be utilized for one or more opportunities 24 set forth below. For example, the reports 22 generated by the health advisor system 10 may include a report having hardware and software maintenance recommendations for the HMI 12 (e.g., HMI health assessment report). In certain embodiments, the reports 22 generated by the health advisor system 10 may, additionally or alternatively, include the hardware and/or software configuration of the HMI 12 (e.g., a HMI configuration report).

In certain embodiments, the health advisor database 16 of the HMI health advisor system 10 may include, for example, rule-based information detailing expert knowledge on successful configurations of the HMI 12, as well as knowledge useful in making deductions or predictions regarding the health of the HMI 12. Additionally, in certain embodiments, the rules in the health advisor database 16 may be based on information gleaned from the operations of other HMI systems, service updates, product service bulletins, cybersecurity alerts, cybersecurity regulations, North American Electric Reliability Corporation (NERC) recommendations, technical information letters (TILS), and/or the HMI 12 or software user manuals. For example, in certain embodiments, the health advisor database 16 may include expert system rules (e.g., forward chained expert system, backward chained expert system), regression models (e.g., linear regression, non-linear regression), fuzzy logic models (e.g., predictive fuzzy logic models), and other predictive models (e.g., Markov chain models, Bayesian models, support vector machine models) that may be used to predict the health, the configuration, and/or the probability of occurrence of undesired maintenance events (e.g., failure of a power supply, failure of a processor core, failure of an input/output [I/O]) pack, insufficient memory, loose bus connection, application deadlock or starvation, application failure or instability, application conflict, or other undesired maintenance event) related to the HMI 12. Furthermore, in certain embodiments, the HMI health advisor system 10 may continually or intermittently update the rules in the health advisor database 16 based on new information gleaned from the health assessment of other HMIs (e.g., the reports 22 generated for the HMI 12) as these devices are analyzed.

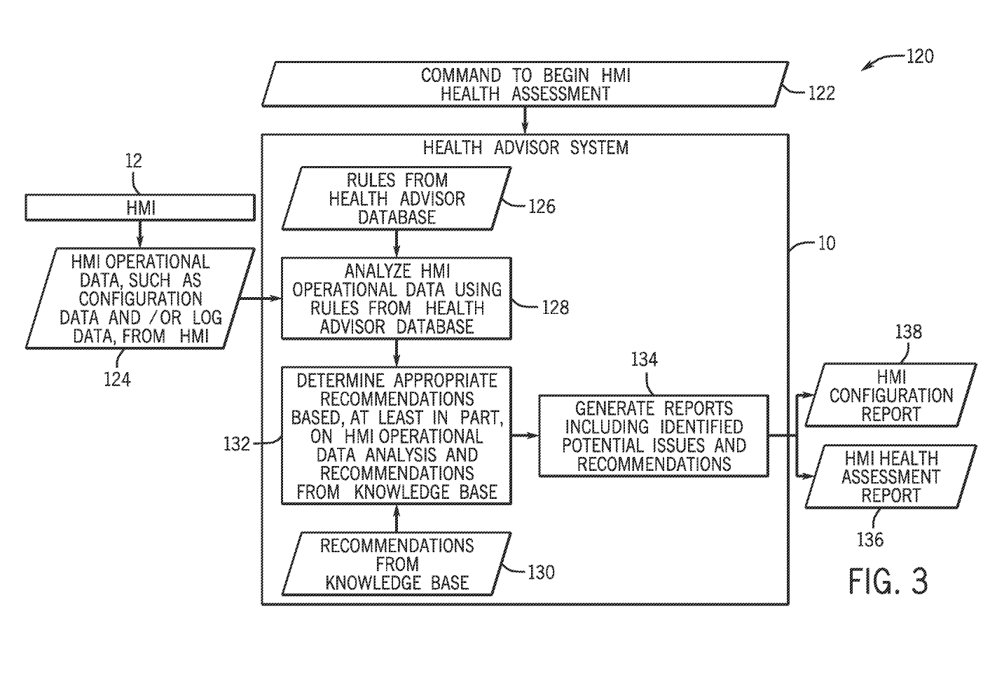

By specific example, in an embodiment, the health advisor database 16 may include rules pertaining to software compatibility of the various software packages and/or preferred versions of software installed on the HMI 12. Accordingly, the health advisor database 16 may store a number of rules indicating that certain combinations of software packages installed on the HMI 12 may be incompatible with one another (e.g., result in unexpected output or termination when executed by the same processor). As such, upon applying these rules to the HMI configuration information and/or log data, the health advisor suite 18 may determine that incompatible software (e.g., incompatible versions of two software packages) may present on the HMI 12, which may warrant the removal, replacement, or upgrade of the incompatible software by the operator. The rules of the health advisor database 16 are discussed in greater detail below, with respect to FIG. 3.

In this manner, the health advisor suite 18 may utilize the rules from the health advisor database 16 to analyze the configuration information and/or log data of the HMI 12 and identify potential issues or problems. Once the future issues have been identified, the health advisor database 16 may utilize data stored in the knowledge base 20 to determine or identify solutions to these identified issues. As such, in certain embodiments, the knowledge base 20 of the HMI health advisor system 10 may include one or more solutions to known issues or concerns with the HMI 12, including, for example, known effective HMI configurations and/or tested solutions to known HMI hardware or software issues. Additionally, the knowledge base 20 may include information gleaned from service updates, product service bulletins, cybersecurity alerts, cybersecurity regulations, NERC recommendations, TILs, and/or information gleaned from the HMI or software user manuals. Furthermore, in certain embodiments, the health advisor suite 18 may continually or intermittently update the knowledge base 20 based on new information gleaned from the health assessment of other HMIs (e.g., the reports 22 generated for the HMI 12) as these devices are analyzed. Furthermore, in certain embodiments, the knowledge base 20 and/or the health advisor database 16 may be accessible (e.g., via a network connection) such that a customer may access the recommendations stored in the knowledge base 20 via other applications or interfaces.

The reports 22 generated by the health advisor system 10 (e.g., the HMI health assessment and/or the HMI configuration report) may be used in a number of ways, illustrated by opportunities 24 of FIG. 1. For example, the reports 22 may be used to support a new product introduction (NPI) 28 and/or perform a root cause analysis (RCA) 30 (e.g., regarding the HMI 12 and/or other components of the industrial control system 14). For example, issues found in the HMI health assessment (e.g., reports 22) may aid in identifying issues related to an introduction of a new hardware or software component for the HMI 12, or the introduction of a newer version of the HMI device 12. The identified issues may then be used to derive a RCA 30 using, for example, fault tree analysis, linear regression analysis, non-linear regression analysis, Markov modeling, reliability block diagrams (RBDs), risk graphs, layer of protection analysis (LOPA), or other suitable analysis technique. The RCA 30 may then be used to re-engineer or otherwise update the HMI 12 and/or other components (e.g., the controller) of the industrial control system 14 to address any identified issues.

By further example, the HMI health assessment included in the reports 22 may also be used (e.g., along with knowledge base 20) to determine engineering opportunities (EO) 32 for the HMI 12 and/or other components of the industrial control system 14. For example, usage patterns of the HMI 12 (e.g., processor usage, memory usage, network usage, program logs, issues found, frequently asked questions, and the like), may be used to derive engineering changes for the HMI 12 and/or other components (e.g., the controller) of the industrial control system 14. In certain embodiments, for the HMI 12, the engineering changes to the HMI 12 may include changing memory paging schemes, memory allocation algorithms, applying CPU optimizations (e.g., assigning process priorities, assigning thread priorities), applying programming optimization (e.g., identifying and rewriting program bottlenecks, adjusting a user interface, using improved memory allocation, using processor-specific instructions), applying networking optimizations (e.g., changing transmit/receive rates, frame sizes, time-to-live (TTL) limits), and so on. For example, engineering opportunities 32 may include modifying and improving remote deployable software upgrades (RDSUs) that may be periodically provided to the customer by the manufacturer of the HMI 12. That is, based on the reports 22, these RDSUs may be adjusted based on problems and/or concerns encountered when the RDSUs are deployed in the field (e.g., at the industrial control system 14).

By further example, the HMI health assessment included in the reports 22 may also be used (e.g., along with the knowledge base 20) to determine revenue opportunities (RO) 34 pertaining to the HMI 12 and/or other components of the industrial control system 14. For example, the HMI health assessment 24 may detail certain upgrades to the HMI 12 and/or other components (e.g., the controller) of the industrial control system 14 that are suitable for improving the performance of the HMI 12 and/or the industrial control system 14. Such upgrades may include software updates, such as newer versions of the HMI, distributed control system (DCS), manufacturing execution system (MES), and/or supervisor control and data acquisition (SCADA) system. Upgrades may also include hardware updates such as updates to an input/output system (e.g., I/O pack), a memory, processors, a network or network interface, a power supply, and/or a communications bus. By using the heath advisor suite 18 to derive the health assessment 24, the techniques described herein may enable a more efficient power plant 14, as well as reduced operating costs.

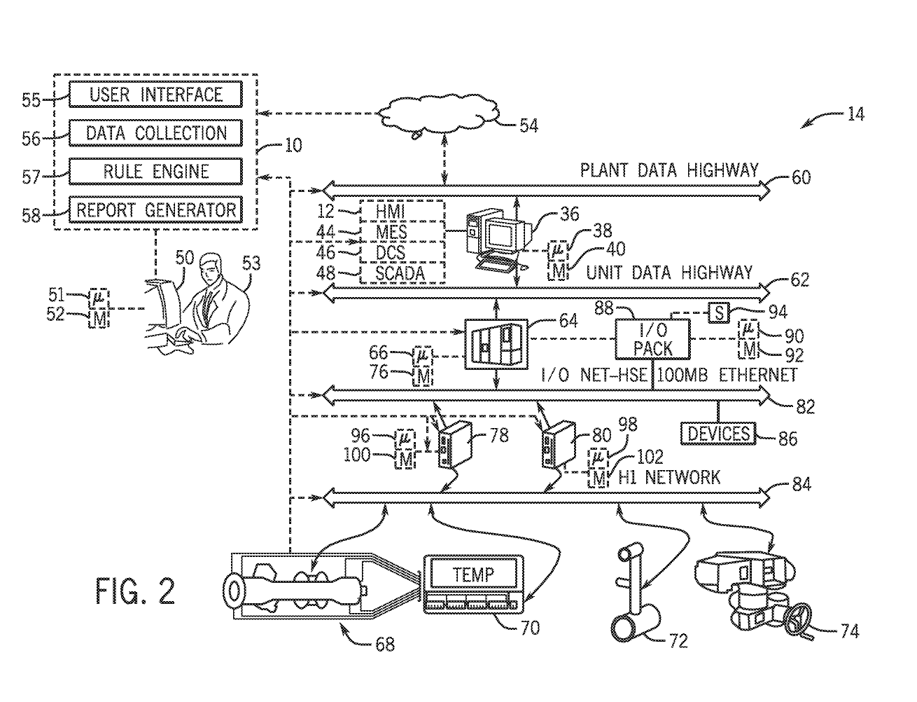

FIG. 2 is a schematic diagram depicting an embodiment of the industrial control system 14 (e.g., power plant 14) communicatively coupled to the HMI health advisor system 10. The industrial control system 14 may include a computer system 36 suitable for executing a variety of control and monitoring applications, such as the HMI 12, to provide an operator interface through which an engineer or technician may monitor the components of the industrial control system 14. Accordingly, the computer 36 includes a processor 38 that may be used in processing computer instructions, and a memory 40 that may be used to store computer instructions and other data. The computer system 36 may include any type of computing device suitable for running software applications, such as a laptop, a workstation, a tablet computer, or a handheld portable device (e.g., personal digital assistant or cell phone). Indeed, the computer system 36 may include any of a variety of hardware and/or operating system platforms. In accordance with one embodiment, the computer 36 may host other industrial control software, such as a manufacturing execution system (MES) 44, a distributed control system (DCS) 46, and/or a supervisor control and data acquisition (SCADA) system 48. The HMI 12, MES 44, DCS 46, and/or SCADA 48 may be stored as executable code instructions stored on non-transitory tangible computer readable media, such as the memory 40 of the computer 36. For example, the computer 36 may host the ControlST™ and/or ToolboxST™ software, available from General Electric Co., of Schenectady, N.Y.

In certain embodiments, the HMI 12 may be a redundant device suitable for providing failover or redundant operations. In such embodiments, the HMI 12 (e.g., the computer 36 hosting HMI 12) may include three cores or separate controllers (e.g., cores R, S, and T) and may be referred to as a Triple Module Redundant (TMR) HMI 12. In certain embodiments, two of the three cores may remain idle while the HMI 12 is executed by the third core. In such embodiments, the second and third idle cores may be configured, when properly functioning, to seamlessly resume execution of the HMI 12 if the executing core fails. In other embodiments, the various cores may cooperate to execute the HMI 12 (e.g., using polling and/or voting techniques). In this manner, the HMI 12 may rely on the plurality of cores to provide a reliable system for the operator to visualize and control the industrial control system 14 despite hardware (e.g., core) failures. As discussed below, the presently disclosed health advisor system 10 is capable of assessing the redundancy of the HMI 12 for the reports 22.

The illustrated HMI health advisor system 10 is executed by computer 50 (e.g., including processor 51 and memory 52), which may be used by the operator 53 to interface with the health advisor system 10. Accordingly, the computer 50 may include various input and output devices (e.g., mouse, keyboard, monitor, touchscreen, printer, or other suitable input or output device) such that the operator 53 may provide commands to the health advisor system 10 and receive reports 22 from the health advisor system 10. Furthermore, in certain embodiments, the computer 50 (e.g., the health advisor system 10) may be communicatively coupled to the computer system 36 (e.g., the HMI 12) through direct or indirect techniques in order to receive information regarding the operation of the HMI 12. For example, a signal conduit (e.g., cable, wireless router) may be used to directly couple the computer 50 to the computer 36. Likewise, a file transfer mechanism (e.g., remote desktop protocol (RDP), file transfer protocol (FTP), manual transfer, or other suitable mechanism) may be used to indirectly send or to receive data (e.g., files). Further, cloud 54 computing techniques may be used, in which all or part of the HMI health advisor system 10 resides in the cloud 54 and communicates directly or indirectly with the computer system 36 (e.g., via a network or the Internet).

In certain embodiments, the HMI health advisor system 10 may include a number of subsystems or components, such as a user interface component 55, a data collection component 56, a rule engine component 57, and/or a report generator component 58. These components of the illustrated HMI health advisor system 10 may be implemented by using computer instructions stored in a non-transitory machine-readable medium, such as the memory of a computer, a laptop, a notebook, a tablet, a cell phone, and/or a personal digital assistant (PDA). As discussed in greater detail below, the user interface component 55 of the health advisor system 10 may generally provide the operator 53 with an interface (e.g., a graphical user interface (GUI)) to provide commands to the HMI health advisor system 10. For example, the operator 53 may use the user interface component 55 of the HMI health advisor system 10 to provide the system with commands or instructions to assess a particular HMI 12, to assess a particular feature of the HMI 12 (e.g., redundancy check), to halt an assessment of the HMI 12, and so forth. Furthermore, the user interface component 55 may also be used to provide the reports 22 (e.g., the HMI health assessment report and/or HMI configuration report) to the operator 53 (e.g., via a display, printer, or similar output device).

In certain embodiments, the health advisor system 10 may include a data collection component 56 to collect and store operational data related to the HMI 12 (e.g., data representative of the configuration, status, health, and operating condition of the HMI 12). The data collection component 56 may be continuously operating or periodically activated, and may include relational databases, network databases, files, and so on, useful in storing and updating stored data. For example, as set forth below, the data collection component 56 may be used to collect (e.g., via a network connection) the various configurations of software and/or hardware components of the HMI 12 by collecting one or more configuration files and/or log files from the HMI 12 (e.g., from the memory 40 of the computer 36 executing the HMI 12).

In certain embodiments of the HMI health advisor system 10, a rule engine component 57 may be used to enable the determination of the health of the HMI 12 from the operational data of the HMI 12, as described in more detail below with respect to FIG. 3. These rules may include a number of different types of rules that generally encode expert knowledge regarding potential problems that the HMI 12 may encounter during operations. As such, in certain embodiments, the rule engine component 57 may request and receive a plurality of rules from the health advisor database 16, and then apply these rules to the operational data (e.g., the configuration and log files collected by the data collection component 54) in order to predict potential issues that the HMI 12 is likely to experience in the future. These rules are discussed in greater detail below, with respect to FIG. 3.

In certain embodiments of the health advisor system 10, a report generator component 58 may be used to produce one or more reports 22 regarding the health and status of the HMI 12. That is, in certain embodiments, once the rule engine 57 has applied rules to the operational data of the HMI 12 to identify potential issues that the HMI 12 is likely to encounter, the report generator component 58 may generate a number of reports 22 regarding the health and status of the HMI 12. In certain embodiments, the report generator component 58 of the health assessment system 10 may request and receive a number of potential solutions from the knowledge base 20 for the potential issues of the HMI 12 identified by the rule engine 57. Accordingly, the report generator component 58 may include all or some of these potential solutions, along with the details of the potential issues, in the reports 22.

In the illustrated industrial control system 14, the computer system 36 and the health advisor system 10 are communicatively connected to a plant data highway 60 of the industrial control system 14 suitable for enabling communication between the depicted computer 36 and other computers 50 and/or health advisor systems 10. Indeed, in certain embodiments, the industrial control system 14 may include multiple computer systems 36 interconnected through the plant data highway 60, or through other data buses (e.g., local area networks, wide area networks). In one embodiment, the industrial controller 64 of the industrial control system 14 may include a processor 66 suitable for executing computer instructions or control logic useful in automating a variety of equipment in the industrial control system 14 (e.g., power plant 14), such as a turbine system 68, a temperature sensor 70, a valve 72, a pump 74, or any other suitable component of the industrial control system 14. The industrial controller 64 may further include a memory 76 for use in storing, for example, control code (e.g., computer instructions and other data). For example, the industrial controller 64 may store one or more function blocks written in an International Electrotechnical Commission (IEC) 61804 language standard, sequential function charts (SFC), ladder logic, or programs written in other programming languages, in the control code. In certain embodiments, the industrial controller 64 may include configuration parameters, such as instantiated function blocks (e.g., function blocks to load into memory), networking parameters, code synchronization and timing, I/O configuration, amount of memory to use, memory allocation parameters (e.g., memory paging parameters) and so on.

Furthermore, the illustrated industrial controller 64 may communicate with a variety of field devices, including but not limited to flow meters, pH sensors, temperature sensors, vibration sensors, clearance sensors (e.g., measuring distances between a rotating component and a stationary component), pressure sensors, pumps, actuators, valves, and the like. In some embodiments, the industrial controller 64 may be a triple modular redundant (TMR) Mark™ VIe controller system, available from General Electric Co., of Schenectady, N.Y. By including three processors, the TMR controller 64 may provide for redundant or fault-tolerant operations. In other embodiments, the controller 64 may include a single processor, or dual processors.

In the depicted embodiment, the turbine system 68, the temperature sensor 70, the valve 72, and the pump 74 are communicatively connected to the industrial controller 64 and/or the health advisor 18 by using linking devices 78 and 80 suitable for interfacing between an I/O network 82 and an H1 network 84. For example, the linking devices 78 and 80 may include the FG-100 linking device, available from Softing AG, of Haar, Germany. Additional field devices 86 (e.g., sensors, pumps, valves, actuators) may be communicatively coupled via the I/O network 82 to the controller 64 and/or the health advisor 18, for example, by using one or more input/output (I/O) packs 88. The I/O packs 88 may each include a microprocessor 90 useful in executing a real-time operating system, such as QNX® available from QNX Software Systems/Research in Motion (RIM) of Waterloo, Ontario, Canada. Each I/O pack 88 may also include a memory 92 for storing computing instructions and other data, as well as one or more sensors 94, such as temperature sensors, useful in monitoring the ambient temperature in the I/O packs 88. In other embodiments, the turbine system 68, the temperature sensor 70, the valve 72, the pump 74, and/or the field devices 86, may be connected to the controller 64 by using direct cabling (e.g., via a terminal block) or indirect connections (e.g., file transfers).

As depicted, the linking devices 78 and 80 may include processors 96 and 98, respectively, useful in executing computer instructions, and may also include memory 100 and 102, useful in storing computer instructions and other data. In some embodiments, the I/O network 82 may be a 100 Megabit (MB) high speed Ethernet (HSE) network, and the H1 network 84 may be a 31.25 kilobit/second network. Accordingly, data transmitted and received through the I/O network 82 may in turn be transmitted and received by the H1 network 84. That is, the linking devices 78 and 80 may act as bridges between the I/O network 82 and the H1 network 84. For example, higher speed data on the I/O network 82 may be buffered, and then transmitted at suitable speed on the H1 network 84. For example, the field devices 68, 70, 72, and 74 may include or may be industrial devices, such as Fieldbus Foundation™ devices that include support for the Foundation H1 bi-directional communications protocol. The field devices 68, 70, 72, 74, and 86 may also include support for other communication protocols, such as those found in the HART® Communications Foundation (HCF) protocol, and the Profibus Nutzer Organization e.V. (PNO) protocol.

FIG. 3 is a hybrid flow diagram illustrating the flow of information for an embodiment of the process 120 by which the HMI health advisor system 10 assesses the health of the HMI 12 of the industrial control system 14. The illustrated process 120 may be implemented by using computer instructions stored in a non-transitory machine-readable medium, such as the memory of a computer, a laptop, a notebook, a tablet, a cell phone, and/or a personal digital assistant (PDA). For the illustrated process 120, the health advisor system 10 first receives (block 122) a command to begin an HMI health assessment. In certain embodiments, the operator 53 may additionally command the HMI health advisor system 10 to perform a HMI redundancy check, as discussed below. In certain embodiments, the operator 53 may utilize one or more input devices coupled to the processor (e.g., computer 36) that is executing the health advisor suite 18 to interact with the user interface component 55 of the HMI health advisor system 10. For example, in certain embodiments, this user interface component 55 may enable the operator of the health advisor system 10 to select a particular HMI 12 in the industrial control system 14 to assess, to select particular analyses to be performed on the HMI 12 (e.g., a redundancy check), and to provide commands to the HMI health advisor system 10 to begin and/or halt the assessment of the HMI 12.

Once the health advisor system 10 has received instructions to proceed with the health assessment of the HMI 12, the health advisor system 10 (e.g., the data collection component 56) may collect operational data 124 regarding the HMI 12. For example, the operational data 124 may include configuration files, log files, memory dumps, or other suitable data pertaining to the configuration (e.g., settings, variables, installed hardware/software, etc.) or operation (e.g., hardware and/or software events, such as errors, problems, warnings, encountered during operation) of the HMI 12. For example, in certain embodiments, the HMI health advisor system 10 may utilize the data collection component 56 to retrieve the operational data 124 from the HMI 12 over a suitable network connection (e.g., plant data highway 60). Additionally, the data collection subsystem 54 of the health advisor system 10 may generally collect the operational data from the HMI 12 in an efficient manner (e.g., in a single pass and/or during period of reduced activity of the HMI 12) so as to not substantially interfere with the operation of the HMI 12. In certain embodiments, the operator 53 may utilize the aforementioned user interface component 55 of the HMI health advisor system 10 to provide operational data 124 from the HMI 12 (e.g., manually collected from the HMI 12 by the operator 53) to the HMI health advisor system 10. For example, the operator 53 may utilize the user interface component 55 to point the HMI health advisor system 10 to one or more files loaded onto a storage medium (e.g., a CD, DVD, flash card, thumb drive, hard drive, or other suitable storage medium) storing the operational data 124 for the HMI 12 for analysis.

By specific example, in an embodiment, the operational data 124 for an HMI 12 may include details for some or all software (e.g., software tools, operating systems, networking software, firmware, microcode, display drivers, sound drivers, network drivers, I/O system drivers) installed on and/or used by the HMI 12 during operation. For example, in one embodiment, details may include operating system (OS) version, OS service pack version, software and OS patches installed, driver version, application version, application service pack version, or a combination thereof. Furthermore, in certain embodiments, the operational data 124 for an HMI 12 may include details for all hardware (e.g., hardware component type, hardware component version, hardware component vendor, and so forth) installed on and/or used by the HMI 12 during operation. In certain embodiments, the operational data 124 includes log data storing details regarding a status of the HMI 12 (e.g., memory usage, processor usage, storage space available, etc.) as well as a plurality of hardware events, software events, user events, or a combination thereof, experienced by the HMI 12 during operation.

Once the HMI health advisor system 10 has received the operational data 124 directly (e.g., from the HMI 12) or indirectly (e.g., from a storage medium provided by the operator 53), the health advisor system 10 may utilize rules 126 from the health advisor database to analyze (block 128) the operational data 124 of the HMI 12 and proactively identify potential issues. In certain embodiments, the rules 126 may include “if . . . then . . . ” rules, with the “if” portion set as an antecedent condition, and the “then” portion set as a consequent of the antecedent condition. The rules 126 may also include fuzzy logic rules, expert system rules (e.g., forward chained expert systems, backward chained expert systems), recursive rules (e.g., Prolog rules), Bayesian inference rules, dynamic logic rules (e.g., modal logic), neural network rules, genetic algorithm rules, or a combination thereof The rules 126 may be derived through consultation with one or more experts in the field, such as HMI health experts, or automatically, such as by using machine learning techniques (e.g., reinforcement learning, decision tree learning, inductive logic programming, neural network training, clustering, support vector machine). In addition or in alternative to these rules 126, other statistical and historical analysis techniques may also be used, such as fault tree analysis, linear regression analysis, non-linear regression analysis, Markov modeling, RBDs, risk graphs, LOPA, Poisson distribution model, Weibull analysis, and/or Markov chain modeling.

After the operational data 124 from the HMI 12 has been analyzed (block 128), the health advisor system 10 use recommendations 130 from the knowledge base 20 to determine (block 132) appropriate recommendations based, at least in part, on the analysis of the operational data 124 of the HMI 12 (e.g., performed in block 128). For example, a proactively identified HMI issue may include identifying two incompatible pieces of software (e.g., the HMI 12 and the MES 44) through analysis of the operational data 124. Accordingly, the HMI health advisor system 10 may determine a number of potential solutions for the issue (e.g., moving HMI 12 or MES 44 to a separate device or processor, upgrading the HMI 12 to a newer version, upgrading the MES 44 to a newer version, and so forth). As discussed below, in certain embodiments, the potential solutions from the knowledge base 20 may be partially or entirely included in the reports 22 generated by the HMI health advisor system 10.

After determining the appropriate recommendations, the HMI health advisor system 10 (e.g., the report generator component 58 of the health advisor system 10) may generate (block 134) and output a HMI health assessment report 136 and HMI configuration report 138 for the HMI 12. The HMI configuration report 138 may include details of the configuration of the HMI 12. The configuration details may include a list of all software and hardware components used by the HMI 12 (e.g., including details of the components 12, 38, 40, 44, 46, and/or 48 of the industrial control system 14 of FIG. 2). The details may include details regarding the hardware and software components used by the HMI 12, such as version information for each component (e.g., hardware version, firmware version, software version, microcode version, and so forth). The HMI configuration report 124 may also illustrate the hardware and/or software components of the HMI 12 in a visual manner (e.g., using graphs, charts, block diagrams, or other suitable visual presentation). Furthermore, in certain embodiments, the HMI configuration report 138 may be generated in a non expert format, in which certain terminology that may not be generally understood by non-experts of the HMI 12 may be substituted for related, terminology or phrasing that may be more readily understood by non-experts of the HMI 12. For example, instead of stating that the HMI 12 is a “TMR HMI”, the configuration report 138 may instead state that the HMI 12 has a “level of redundancy” value equal to three.

As mentioned, the HMI health assessment report 136 may include recommendations regarding modifications and improvements for the HMI 12. For example, certain hardware and software upgrades or additions for the HMI 12 (e.g., based on recommendations from the knowledge base 20) may be recommended. The hardware upgrades may include memory upgrades, network equipment upgrades, processor upgrades, replacement of components of the HMI 12, replacement of cabling, replacement of power supplies, and so forth. The HMI health assessment report 136 may also include recommendations to add or remove certain component and related subsystems, for example to enable faster control and/or faster processing of data. The software recommendations may include upgrading, removing, or relocating certain obsolete software components of the computer 36 (e.g., HMI 12, MES, 44, DCS 46, SCADA 48), operating systems, software tools, firmware, microcode, applications, and so on. The HMI health assessment report 136 may further include a list of issues that may lead to undesired conditions, such as unexpected maintenance events or stoppage of the HMI 12. For example, the HMI health assessment report 136 may include warnings regarding insufficient memory 40, loss of redundancy of the HMI 12, limited capacity or bandwidth, insufficient processing power for the processor 38, failure of any of the components of the computer 36, software errors, hardware errors, security errors, and so forth. Accordingly, the HMI health advisor system 10 may determine a number of potential solutions for the issue (e.g., moving HMI 12 or MES 44 to a separate device or processor, upgrading the HMI 12 to a newer version, upgrading the MES 44 to a newer version, and so forth). In certain embodiments, the HMI health advisor system 10 may only select the most appropriate solutions from the knowledge base 20 for inclusion in the HMI health assessment report 136. In other embodiments, the health advisor system 10 may include all of the recommendations in the HMI health assessment report 136 and may, furthermore, rate the individual solutions (e.g., based on a 0%-100% score) based, at least in part, on the similarity of the issue proactively identified in the HMI 12 to the issue corresponding to the solution from the knowledge base 20.

Furthermore, in certain embodiments involving a redundant HMI (e.g., a TMR HMI), the HMI health assessment report 136 may also include a measure of the effectiveness of the redundancy of the HMI. For example, the HMI health assessment report 136 may include the condition of a TMR HMI 12, including any detected fault conditions, alarm reports based on alarm logging data, error reports based on error logging data, and may also derive an overall redundancy effectiveness or readiness metric from the operational data 124. For example, the readiness metric may detail an approximate percentage readiness or stability level (e.g., 0%-100%) for the HMI 12, wherein a higher number for the percentage readiness or stability may indicate that the HMI 12 is more suitable for continued operations, while a lower number for the percentage readiness or stability may indicate that the HMI 12 is less suitable for continued operations. The percentage readiness may be derived by using certain of the rules 127 focused on determining how effectively the redundancy features of the HMI 12 would function in operation. In certain embodiments, the percentage readiness may also be found by using a statistical or historical analysis based on the inputs, such as a Poisson distribution model, linear regression analysis, non-linear regression analysis, Weibull analysis, fault tree analysis, Markov chain modeling, and so on.

Once generated, the HMI health assessment report 136 and the HMI configuration report 138 may be provided to the operator 53 and/or other user roles (e.g., system administrators, plant operators, commissioning engineers, managers, programmers, control engineers, procurement personnel, accounting personnel), as well as stored in, for example, the knowledge base 20. The operator 53 may then use the provided reports 136 and 138 to improve the HMI 12 and/or the industrial control system 14. For example, components of the HMI 12 or the computer 36 may be replaced, added, or upgraded based on the reports 136 and 138. Likewise, NPI 28 and RCA 30, EO 32 and/or RO 34 may be derived and used to more efficiently engineer and operate the HMI 12 and/or industrial control system 14.

Technical effects of the present techniques include the collection and analysis of HMI operational data 124 (e.g., configuration and/or logs files) to derive a health assessment for a HMI 12 without substantially disrupting the operation of the HMI 12. Present embodiments enable a rule-based analysis of HMI operational data 124 to proactively identify potential problems the HMI 12 is likely to encounter during future operation. By using the disclosed rule-based approach, expert knowledge encoded in the rules may be quickly applied over a fleet of HMI devices to diagnose HMI issues without actually requiring direct expert attention, and knowledge and solutions pertaining to these HMI issues may be readily shared and tested within the fleet. The disclosed embodiments provide one or more reports 22, such as the HMI health assessment report 136 and the HMI configuration report 138, which may include configuration information as well as proactively identified problems and recommended solutions for the HMI 12. Also, the disclosed embodiments may include data storage components, such as the health advisor database 16 and the knowledge base 20, which may be periodically updated based on these reports 22, continually expanding the capabilities of the health advisor system 10. Furthermore, using the reports 22, the HMI health advisor system 10 may enable an up-to-date prognosis of the health of the HMI 12, and may be used to derive the NPI 28, the RCA 30, the engineering opportunities 32, and/or the revenue opportunities 34 for the HMI 12 and/or the industrial control system 14.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a human machine interface (HMI) health advisor system comprising:
a health advisor suite comprising a processor configured to:
receive operational data regarding a HMI device, wherein the operational data comprises configuration data, log data, or a combination thereof;
apply a plurality of rules to the operational data to proactively determine a HMI issue;
identify a solution to the HMI issue from a plurality of known solutions to HMI issues;
generate a configuration report for the HMI device based on the received configuration data; and
generate a health assessment report for the HMI device, wherein the health assessment report comprises the HMI issue and the solution to the HMI issue.

2. The system of claim 1, wherein the configuration data comprises details regarding a plurality of hardware and software components installed on the HMI device.

3. The system of claim 2, wherein the details regarding the software components installed on the HMI device comprise an operating system (OS) version, OS service pack version, driver version, application version, application service pack version, or a combination thereof

4. The system of claim 2, wherein the details regarding the hardware components installed on the HMI device comprise hardware component type, hardware component version, hardware component vendor, or a combination thereof

5. The system of claim 2, wherein the log data comprises details regarding a plurality of hardware events, software events, user events, or a combination thereof, experienced by the HMI device during operation.

6. The system of claim 1, wherein the health advisor suite is configured to receive the operational data regarding the HMI device from an operator of the HMI health advisor system.

7. The system of claim 1, wherein the HMI health advisor system comprises a health advisor database configured to:
store the plurality of rules;
provide the plurality of rules to the health advisor suite;
receive the configuration report, the health assessment report, or both, from the health advisor suite; and
update the stored plurality of rules based on the configuration report, the health assessment report, or both.

8. The system of claim 7, wherein the plurality of rules stored by the health advisor database comprise a plurality of “if . . . then” rules, and wherein the health advisor suite is configured to apply the plurality of “if . . . then” rules to the received operational data to proactively determine the HMI issue.

9. The system of claim 1, wherein the HMI health advisor system comprises a knowledge base configured to:
store the plurality of known solutions to HMI issues;
provide the plurality of known solutions to the health advisor suite;
receive the configuration report, the health assessment report, or both, from the health advisor suite; and
update the stored plurality of known solutions based on the received configuration report, the health assessment report, or both.

10. The system of claim 10, comprising the HMI device, wherein the HMI device is configured to provide an interface for an operator to visualize and control an industrial control system, and wherein the industrial system comprises a gasification system, a turbine system, a gas treatment system, a power generation system, or a combination thereof.

11. The system of claim 1, wherein the health advisor suite is configured to periodically receive updated operational data regarding the HMI device generate an updated health assessment report for the HMI based, at least in part, on the updated operational data.

12. A method comprising:
receiving, via a processor of an electronic device, configuration data, log data, or both, from a human machine interface (HMI) device;
applying, via the processor, a plurality of rules to the configuration data, the log data, or both, to predict one or more potential future maintenance issues for the HMI device;
determining, via the processor, one or more corresponding solutions from a plurality of known solutions for the one or more potential future maintenance issues for the HMI device; and
reporting a health assessment of the HMI device, wherein the health assessment comprises the one or more potential future maintenance issues for the HMI device and the one or more corresponding solutions.

13. The method of claim 12, comprising receiving the plurality of rules from a health advisor database and receiving the plurality of solutions from a knowledge base.

14. The method of claim 13, comprising updating the plurality of rules in the health advisor database and updating the plurality of solutions from the knowledge base based, at least in part, on the health assessment.

15. The method of claim 12, generating a configuration report for the HMI device based on the configuration data received from the HMI device, wherein the configuration report comprises details regarding a plurality of hardware and software components installed on the HMI device.

16. The method of claim 12, wherein the health assement comprises a measure of compliance of the HMI device with one or more product manuals, product service bulletins, cybersecurity alerts, North American Electric Reliability Corporation (NERC) recommendations, or a combination thereof

17. The method of claim 12, wherein the HMI device is a HMI device having redundancy, and wherein the HMI health assement comprises an assessment of the redundancy of the HMI device.

18. A non-transitory, computer-readable medium comprising instructions executable by a processor of an electronic device, the instructions comprising instructions to:
receive a command to proceed with a health assessment of a human machine interface (HMI) device;
receive operational data regarding a human machine interface (HMI) device;
receive a plurality of rules from a health advisor database;
apply the plurality of rules to the operational data to predict a future problem relating to the HMI device;
receive a plurality of known solutions from a knowledge base based, at least in part, on the future problem relating to the HMI device;
provide a health assessment report, wherein the health assessment report comprises the future problem of the HMI device and one or more of the plurality of known solutions.

19. The medium of claim 18, wherein the instructions comprise instructions to:
receive a command to proceed with a redundancy assessment of the HMI device;
apply the plurality of rules to the operational data in order to determine a measure of an effectiveness of a redundancy of the HMI device; and
provide the health assessment report, wherein the health assessment report comprises the measure of the effectiveness of the redundancy of the HMI device.

20. The medium of claim 18, wherein the operational data is retreived from the HMI device without substantially interrupting operations of the HMI device.
